(19) United States
(12) Patent Application Publication
(10) Pub. No.: US 2006/0251388 A1
(43) Pub. Date: Nov. 9, 2006

(54) Recording control apparatus and recording control method

(75) Inventors: Shoichi Taya, Hidaka-shi (JP); Teruo Tajima, Isesaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/398,595

(22) Filed: Apr. 6, 2006

(30) Foreign Application Priority Data
Apr. 7, 2005 (JP) 2005-111140

(51) Int. Cl. H04N 5/91

(52) U.S. Cl. 386/83

(57) ABSTRACT

According to one embodiment, in a recording control method, an information recording destination is managed upon dividing into a first area and a second area, and a specific function using the first area and recording of recording target information using the second area are controlled.

### CROSS-REFERENCE TO RELATED APPLICATIONS

This application is based upon and claims the benefit of priority from Japanese Patent Application No. 2005-111140, filed Apr. 7, 2005, the entire contents of which are incorporated herein by reference.

### BACKGROUND

1. Field

One embodiment of the invention relates to a recording control apparatus and recording control method, which can be applied to a recording apparatus for recording information such as a received program.

2. Description of the Related Art

In recent years, a video recording apparatus which records video data in an HDD (Hard Disk Drive) has greatly prevailed. The HDD preferably has a large capacity. It is disclosed by, for example, Jpn. Pat. Appln. KOKAI Publication No. 2004-72396 to automatically receive a desired broadcast program in accordance with favorite information, and automatically record the received broadcast program in a predetermined recording area.

A specific function such as time-shift playback using an HDD has also been proposed. Time-shift playback is a function of starting recording a program currently viewed when a viewer is going to leave while the program is in progress, and starting, after he or she returns, playing back the program which is currently being recorded. That is, only recording is executed while a viewer is absent, and playback and recording are concurrently executed after he or she returns. With this function, a viewer can view a partially viewed program from where he or she left off, without waiting for the completion of recording of the partially viewed program.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing an outer appearance of a digital television broadcast receiving apparatus (recording control apparatus) according to an embodiment of the invention;

FIG. 2 is a block diagram showing the schematic arrangement of the digital television broadcast receiving apparatus (recording control apparatus) according to the embodiment; and

FIG. 3 is a view showing a state wherein a recording destination such as an HDD is managed upon being divided into system and user areas according to the embodiment.

### DETAILED DESCRIPTION

Various embodiments according to the invention will be described hereinafter with reference to the accompanying drawings. In general, according to one embodiment of the invention, an information recording destination is managed upon dividing into a first area and a second area, and a specific function using the first area, and recording of recording target information using the second area are controlled.

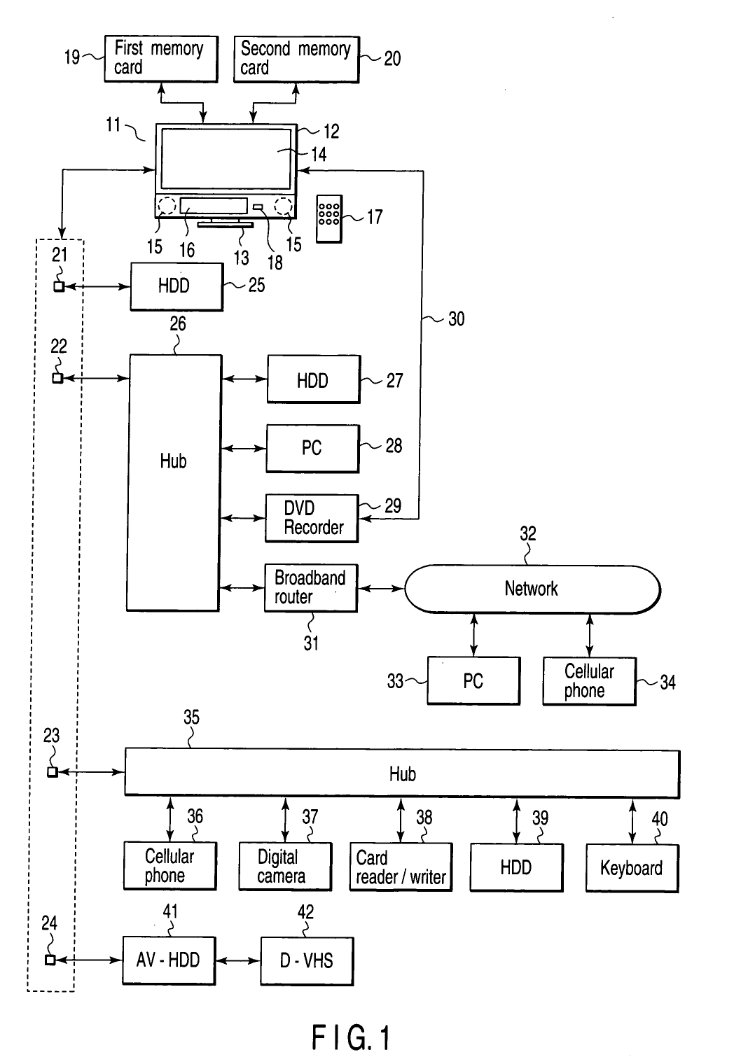

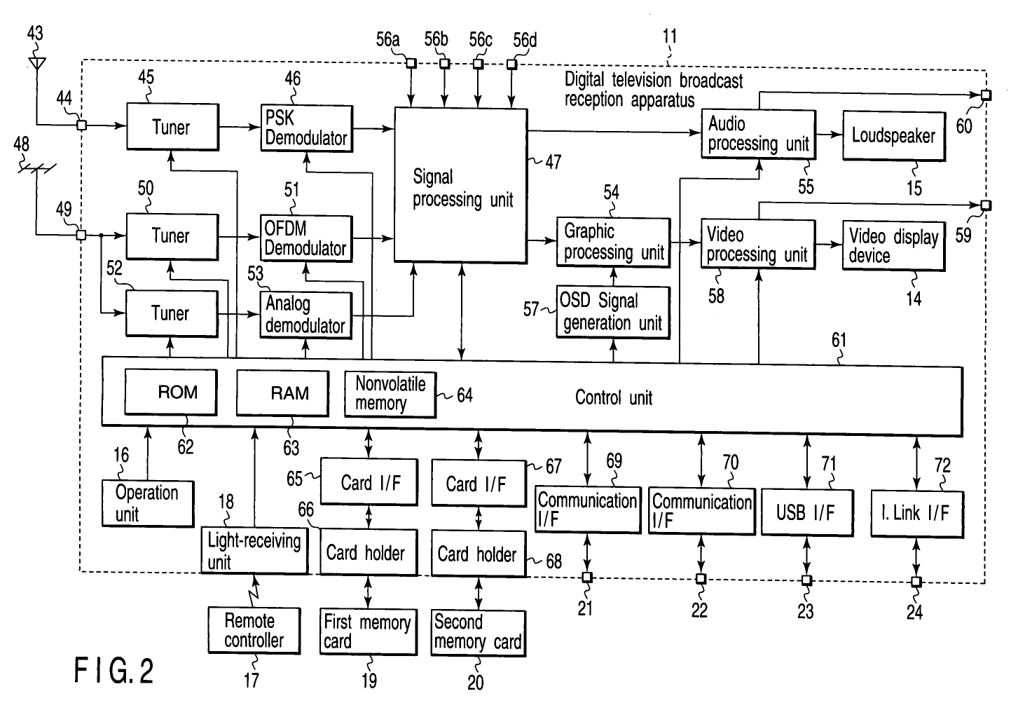

Referring to FIGS. 1 and 2, a digital television broadcast receiving apparatus (recording control apparatus) will be described according to an embodiment. FIG. 1 is a block diagram showing an outer appearance of the digital television broadcast receiving apparatus (recording control apparatus) according to this embodiment. FIG. 2 is a block diagram showing the schematic arrangement of the digital television broadcast receiving apparatus (recording control apparatus).

A digital television broadcast receiving apparatus 11 mainly includes a flat cabinet 12 and a support base 13 which vertically supports the cabinet 12. The cabinet 12 includes a video display device 14 which comprises a liquid crystal display panel or the like, a loudspeaker 15, an operation unit 16, and a light-receiving unit 18 which receives operation information transmitted from a remote controller 17.

A first memory card 19 such as an SD (Secure Digital) memory card, MMC (Multimedia Card), or memory stick is detachable from the digital television broadcast receiving apparatus 11 to execute recording and playback of information such as a program and photograph using the first memory card 19.

A second memory card (IC card) 20 which records contract information and the like is also detachable from the digital television broadcast receiving apparatus 11 to execute recording and playback of information using the second memory card 20.

The digital television broadcast receiving apparatus 11 also has a first LAN (Local Area Network) terminal 21, second LAN terminal 22, USB (Universal Serial Bus) terminal 23, and i. Link terminal 24.

Of these terminals, the first LAN terminal 21 serves as a LAN-compatible HDD dedicated port, and is used to execute recording and playback of information by the Ethernet® using a LAN-compatible HDD 25 serving as a connected NAS (Network Attached Storage).

Since the first LAN terminal 21 serves as the LAN-compatible HDD dedicated port, program information can be stably recorded in the HDD 25 with high-resolution image quality without being influenced by another network environment, a network usage condition, or the like.

The second LAN terminal 22 serves as a general LAN-compatible port using the Ethernet. For example, the second LAN terminal 22 is connected to a LAN-compatible HDD 27, PC (Personal Computer) 28, HDD built-in type DVD (Digital Versatile Disk) recorder 29, and the like via a hub 26, and is used to transmit information to these devices.

Note that digital information communicated via the second LAN terminal 22 is only control system information for the DVD recorder 29. Hence, a dedicated analog transmission channel 30 must be arranged in order to transmit analog video and audio information between the DVD recorder 29 and the digital television broadcast receiving apparatus 11.

The second LAN terminal 22 is also connected to a network 32 such as the Internet via a broadband router 31 connected to the hub 26, and used to transmit information to a PC 33, cellular phone 34, and the like via the network 32.

The USB terminal 23 serves as a general USB-compatible port. For example, the USB terminal 23 is connected to USB devices such as a cellular phone 36, a digital camera 37, a card reader/writer 38 for a memory card, an HDD 39, and a keyboard 40 via a hub 35, and is used to transmit information to these USB devices.

The i. Link terminal 24 is serially connected to, e.g., an AV-HDD 41 and D (Digital)-VHS (Video Home System) 42, and is used to transmit information to these devices.

FIG. 2 shows the main signal processing system of the above-described digital television broadcast receiving apparatus 11. That is, a satellite digital television broadcast signal received by a BS/CS digital broadcast receiving antenna 43 is supplied to a satellite digital broadcast tuner 45 via an input terminal 44 to tune the tuner to the broadcast signal of a desired channel.

The broadcast signal to which the tuner 45 is tuned is supplied to a PSK (Phase Shift Keying) demodulator 46, and demodulated into digital video and audio signals. After that, the demodulated signals are output to a signal processing unit 47.

A terrestrial digital television broadcast signal received by a terrestrial broadcast receiving antenna 48 is supplied to a terrestrial digital broadcast tuner 50 via an input terminal 49 to tune the tuner to the broadcast signal of a desired channel.

The broadcast signal to which the tuner 50 is tuned is supplied to an OFDM (Orthogonal Frequency Division Multiplexing) demodulator 51, and demodulated into digital video and audio signals. After that, the demodulated signals are output to the signal processing unit 47.

The terrestrial analog television broadcast signal received by the terrestrial broadcast receiving antenna 48 is supplied to a terrestrial analog broadcast tuner 52 via the input terminal 49 to tune the tuner to the broadcast signal of a desired channel. The broadcast signal to which the tuner 52 is tuned is then supplied to an analog demodulator 53, and demodulated into analog video and audio signals. After that, the demodulated signals are output to the signal processing unit 47.

Note that, the signal processing unit 47 selectively performs a predetermined digital signal process for the digital video and audio signals respectively supplied from the PSK demodulator 46 and the OFDM demodulator 51. The video and audio signals are output to a graphic processing unit 54 and an audio processing unit 55.

A plurality of (four in FIG. 2) input terminals 56a, 56b, 56c, and 56d are connected to the signal processing unit 47. Each of the input terminals 56a to 56d can receive analog video and audio signals from an external device of the digital television broadcast receiving apparatus 11.

The signal processing unit 47 selectively converts the analog video and audio signals supplied from each of the analog demodulator 53 and the input terminals 56a to 56d into the digital signals. The predetermined digital signal process is performed for the digital video and audio signals. After that, the digital video and audio signals are output to the graphic processing unit 54 and the audio processing unit 55.

Of these processing units, the graphic processing unit 54 has a function of superposing an OSD (On Screen Display) signal generated by an OSD signal generation unit 57 on the digital video signal supplied from the signal processing unit 47, and outputting the resultant signal. The graphic processing unit 54 can selectively output the output video signal from the signal processing unit 47 or the output OSD signal from the OSD signal generation unit 57, or output both the output signals, respectively, on the halves of the window in combination.

The digital video signal output from the graphic processing unit 54 is supplied to a video processing unit 58. The video processing unit 58 converts the input digital video signal into an analog video signal in a format which can be displayed by the video display device 14. After that, the converted analog video signal is output to the video display device 14 for displaying the video signal. The video signal is also output to the external device via an output terminal 59.

The audio processing unit 55 converts the input digital audio signal into the analog audio signal in a format which can be played back by the loudspeaker 15. After that, the converted audio signal is output to the loudspeaker 15 to play back the audio signal. The audio signal is also output to the external device via an output terminal 60.

Note that the control unit 61 systematically controls the operations including the above-described various reception operations of the overall digital television broadcast receiving apparatus 11. The control unit 61 incorporates a CPU (Central Processing Unit) to receive operation information from the operation unit 16. The control unit 61 also receives operation information from the remote controller 17 via the light-receiving unit 18, and controls each device to reflect these operation contents.

In this case, the control unit 61 mainly uses a ROM (Read Only Memory) 62 storing a control program executed by this CPU, a RAM (Random Access Memory) 63 for providing a work area to this CPU, and a nonvolatile memory 64 for storing various setting information and control information.

The control unit 61 is connected, via a card I/F (Interface) 65, to a card holder 66 to which the first memory card 19 can be inserted. In this arrangement, the control unit 61 can transmit, via the card I/F 65, information to the first memory card 19 inserted to the card holder 66.

The control unit 61 is also connected, via a card I/F 67, to a card holder 68 to which the second memory card 20 can be inserted. In this arrangement, the control unit 61 can transmit, via the card I/F 67, information to the second memory card 20 inserted to the card holder 68.

The control unit 61 is also connected to the first LAN terminal 21 via a communication I/F 69. In this arrangement, the control unit 61 can transmit, via the communication I/F 69, information to the LAN-compatible HDD 25 connected to the first LAN terminal 21. In this case, the control unit 61 has a DHCP (Dynamic Host Configuration Protocol) server function to control to allocate an IP (Internet Protocol) address to the LAN-compatible HDD 25 connected to the first LAN terminal 21.

The control unit 61 is also connected to the second LAN terminal 22 via a communication I/F 70. In this arrangement, the control unit 61 can transmit, via the communication I/F 70, information to the devices (see FIG. 1) connected to the second LAN terminal 22.

The control unit 61 is also connected to the USB terminal 23 via a USB I/F 71. In this arrangement, the control unit 61 can transmit, via the USB I/F 71, information to the devices (see FIG. 1) connected to the USB terminal 23.

The control unit 61 is also connected to the i. Link terminal 24 via an i. Link I/F 72. In this arrangement, the control unit 61 can transmit, via the i. Link I/F 72, information to the devices (see FIG. 1) connected to the i. Link terminal 24.

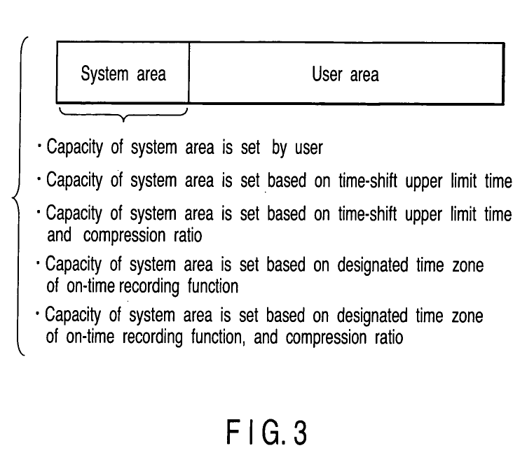

Area management of the above-described digital television broadcast receiving apparatus 11 will be described next. As shown in FIG. 3, the control unit 61 of the digital television broadcast receiving apparatus 11 divides a recording area such as the HDD 25, HDD 27, or AV-HDD 41 into a system area (first area) and a user area (second area), and manages these areas. The digital television broadcast receiving apparatus 11 has a specific function and a general recording function. The control unit 61 serving as a specific function control unit controls the specific function using the system area, and the control unit 61 serving as a recording control unit controls the general recording function using the user area.

The general recording function is to record a currently viewed program based on a recording start/stop instruction from the operation unit 16 or remote controller 17. Additionally, the general recording function is to record a program based on recording reservation information (recording reservation information containing information indicating recording start date and time, recording end date and time, and recording target channel) from the operation unit 16 or remote controller 17.

The specific function includes, e.g., a time-shift playback function and an on-time recording function. For example, the time-shift playback function is called a “time out function”. With this function, for example, a user can view a program which is being broadcast upon shifting (delaying) the time of the program. For example, based on a time-shift instruction from the operation unit 16 or remote controller 17, the control unit 61 starts recording the currently viewed program in the system area. After that, based on a time-shift playback instruction from the operation unit 16 or remote controller 17, the control unit 61 starts playing back the program recorded in the system area. That is, recording starts based on the time-shift instruction, and recording and playback are concurrently executed based on the time-shift playback instruction. More specifically, the user issues the time-shift instruction when he or she is going to leave while the program is in progress. Upon issuing the time-shift playback instruction after he or she returns, the partially viewed program can be viewed from where he or she left off, without waiting for the completion of recording of the partially viewed program.

For example, the on-time recording function is called a “news now” function. This function is to automatically record a program which is broadcast on time. For example, the control unit 61 records, in the system area, the program of a predetermined channel in a predetermined time zone every week or everyday by using the operation unit 16 or remote controller 17. The control unit 61 in an overwrite recording mode overwrites, on an immediately preceding program or the second preceding program recorded in the system area, the program of the predetermined channel in the predetermined time zone recorded every week or everyday by using the operation unit 16 or remote controller 17. With this on-time recording function, for example, news can always be viewed. Additionally, by setting the overwrite recording mode, the latest news can always be viewed.

As shown in FIG. 3, the control unit 61 divides the recording area into the system and user areas to manage these areas. Since a program recording destination is limited to the user area based on the general recording function, the overall storage capacity of the recording destination is prevented from being used up by the program recorded with the general recording function. That is, failure of the specific function can be prevented. Hence, a product function (specific function) can be guaranteed.

The capacities (allocation) of the system and user areas will be described next. For example, based on a capacity designation from the operation unit 16 or remote controller 17, the control unit 61 decides the capacities (allocation) of the system and user areas. That is, according to user's intention, the capacities (allocation) of the system and user areas can be decided.

On the other hand, based on the time-shift upper limit time of the time-shift playback function, the control unit 61 predicts the capacity for time-shift playback. Based on the predicted capacity, the capacity of the system area is decided, and the remaining capacity is allocated to the user area. With the time-shift playback function, for example, the time-shift upper limit time (30 min, 60 min, or the like) can be set based on the time-shift upper limit time setting from the operation unit 16 or remote controller 17. For example, when the time-shift upper limit time is set to 30 min, time-shift playback of 30 min can be made at maximum. The information amount of a program corresponding to 30 min varies depending on a compression ratio. For example, by assuming the lowest compression ratio, a capacity capable of sufficiently recording the program corresponding to 30 min can be ensured.

Based on the time-shift upper limit time and compression ratio of the time-shift playback function, the control unit 61 predicts the capacity for time-shift playback. Based on the predicted capacity, the control unit 61 decides the capacity of the system area, and allocates the remaining capacity to the user area. The user can set a time-shift playback compression ratio via the operation unit 16 or remote controller 17. Based on this time-shift playback compression ratio, a time-shift playback program is compressed and recorded. When a target program is formed by digital data, it is decoded and then re-encoded to be recorded at the set compression ratio.

The control unit 61 also predicts a capacity for on-time recording based on a time zone designated by the on-time recording function. Based on the predicted capacity, the control unit 61 decides the capacity of the system area, and allocates the remaining capacity to the user area. For example, when a program from 11:00 pm to 11:30 pm every week or everyday is designated, the capacity for the program corresponding to 30 min (or 30 min×2 (times)) is ensured in the system area. The information amount of the program corresponding to 30 min varies depending on a compression ratio. For example, by assuming the lowest compression ratio, a capacity capable of sufficiently recording the program corresponding to 30 min can be ensured.

The control unit 61 also predicts a capacity for on-time recording based on the time zone and compression ratio designated by the on-time recording function. On the basis of the predicted capacity, the capacity of the system area is decided, and the remaining capacity is allocated to the user area. The user can set the on-time recording compression ratio via the operation unit 16 or remote controller 17. Based on this on-time recording compression ratio, the on-time recorded program is compressed and recorded. Note that when a target program is formed by digital data, it is decoded, and then re-encoded to be recorded at the set compression ratio.

Note that the recording area managed upon being divided into the system and user areas may be an external HDD or built-in HDD. If the recording area is a built-in HDD, it is not changed by being removed or by an instruction transmitted from another device. Even if the recording area is an external HDD, it is not changed unless it is connected to another device.

Additionally, an area management right can be managed by a password to inhibit an unauthorized change in recording area setting by a person other than an area manager.

Of a plurality of HDDS, one HDD may be allocated to the system area, and another HDD may be allocated to the user area.

Additionally, an HDD saves a file having a predetermined capacity to be ensured as the system area and that having a predetermined capacity to be ensured as the user area, thereby ensuring the predetermined capacities of the system and user areas.

The name of the file corresponding to the system area is decided in advance, and cannot be deleted by user operation.

As described above, even when the free space of the user area is used up (or short) by the general recording function, the above-described specific function is not interfered because the system area is ensured independently of the user area.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording control apparatus comprising:
a management unit configured to manage an information recording destination upon dividing into a first area and a second area;
a specific function control unit configured to control a specific function using the first area; and
a recording control unit configured to control recording of recording target information using the second area.

2. An apparatus according to claim 1, wherein the specific function control unit controls a time-shift playback function of playing back recording target information in the first area based on a time-shift playback instruction while controlling recording of the recording target information for the first area based on a time-shift instruction.

3. An apparatus according to claim 1, wherein the specific function control unit controls an on-time recording function of recording recording target information received from a designated channel in a designated time zone every week or everyday.

4. An apparatus according to claim 1, wherein the specific function control unit controls an on-time recording function of overwriting, on immediately preceding recording target information or second preceding recording target information, recording target information received from a designated channel in a designated time zone every week or everyday.

5. An apparatus according to claim 1, wherein the recording control unit controls recording of recording target information obtained from a selected channel based on a recording start instruction and a recording end instruction, and controls recording of recording target information based on reservation information containing information indicating a recording start date and time, a recording end date and time, and a recording target channel.

6. An apparatus according to claim 1, wherein
the specific function control unit controls a time-shift playback function of playing back recording target information in the first area based on a time-shift playback instruction while controlling, in a set time-shift upper limit time, recording of the recording target information for the first area based on a time-shift instruction, and
the management unit predicts a capacity for time-shift playback based on the set time-shift upper limit time, and decides a capacity of the first area based on the predicted capacity.

7. An apparatus according to claim 1, wherein
the specific function control unit controls an on-time recording function of recording recording target information received from a designated channel in a designated time zone every week or everyday, and
the management unit predicts a capacity of the recording target information based on the designated time zone, and decides a capacity of the first area based on the predicted capacity.

8. An apparatus according to claim 1, wherein
the specific function control unit controls a time-shift playback function of playing back recording target information in the first area based on a time-shift playback instruction while controlling, in a set time-shift upper limit time and at a set compression ratio, recording of the recording target information for the first area based on a time-shift instruction, and
the management unit predicts a capacity for time-shift playback based on the set time-shift upper limit time and the set compression ratio, and decides a capacity of the first area based on the predicted capacity.

9. An apparatus according to claim 1, wherein
the specific function control unit controls, at a set compression ratio, an on-time recording function of recording recording target information received from a designated channel in a designated time zone every week or everyday, and
the management unit predicts a capacity of the recording target information based on the set compression ratio and the designated time zone, and decides a capacity of the first area based on the predicted capacity.

10. A recording control method comprising:
managing an information recording destination upon dividing into a first area and a second area; and
controlling a specific function using the first area, and recording of recording target information using the second area.

11. A method according to claim 10, further comprising:
controlling a time-shift playback function of playing back recording target information in the first area based on a time-shift playback instruction while controlling recording of the recording target information for the first area based on a time-shift instruction.

12. A method according to claim 10, further comprising:
controlling an on-time recording function of recording recording target information received from a designated channel in a designated time zone every week or everyday.

13. A method according to claim 10, further comprising:
controlling an on-time recording function of overwriting, on immediately preceding recording target information or second preceding recording target information, recording target information received from a designated channel in a designated time zone every week or everyday.

14. A method according to claim 10, further comprising:
controlling recording of recording target information obtained from a selected channel based on a recording start instruction and a recording end instruction, and controlling recording of recording target information based on reservation information containing information indicating a recording start date and time, a recording end date and time, and a recording target channel.

15. A method according to claim 10, further comprising:
controlling a time-shift playback function of playing back recording target information in the first area based on a time-shift playback instruction while controlling, in a set time-shift upper limit time, recording of the recording target information for the first area based on a time-shift instruction, and
predicting a capacity for time-shift playback based on the set time-shift upper limit time, and deciding a capacity of the first area based on the predicted capacity.

16. A method according to claim 10, further comprising:
controlling an on-time recording function of recording recording target information received from a designated channel in a designated time zone every week or everyday, and
predicting a capacity of the recording target information based on the designated time zone, and deciding a capacity of the first area based on the predicted capacity.

17. A method according to claim 10, further comprising:
controlling a time-shift playback function of playing back recording target information in the first area based on a time-shift playback instruction while controlling, in a set time-shift upper limit time and at a set compression ratio, recording of the recording target information for the first area based on a time-shift instruction, and
predicting a capacity for time-shift playback based on the set time-shift upper limit time and the set compression ratio, and deciding a capacity of the first area based on the predicted capacity.

18. A method according to claim 10, further comprising:
controlling, at a set compression ratio, an on-time recording function of recording recording target information received from a designated channel in a designated time zone every week or everyday, and
predicting a capacity of the recording target information based on the set compression ratio and the designated time zone, and deciding a capacity of the first area based on the predicted capacity.
